(19) United States
(12) Patent Application Publication
(10) Pub. No.: US 2010/0158516 A1
(43) Pub. Date: Jun. 24, 2010

(54) Integrated Fiber Management for FTTx Architectures

(75) Inventor: Charles I. Cook, Louisville, CO (US)

Correspondence Address: Qwest Communications International Inc., 1801 California St., #900, Denver, CO, 80202, US

(73) Assignee: Qwest Communications International Inc., Denver, CO (US)

(21) Appl. No.: 12/341,308

(22) Filed: Dec. 22, 2008

(51) Int. Cl. H04J 14/00

(52) U.S. Cl. 398/45

(57) ABSTRACT

According to the invention, a system for providing telecommunication services to a plurality of customer premises is disclosed. The system may include a central office and a first plurality of optical fibers. The central office may include a trunk line-out and a first optical line terminal. The first optical line may be in communication with the trunk line-out via at least a first optical line. The first optical line terminal may also include a first optical splitter, internal to the first optical line terminal, configured to split a first communication travelling across the first optical line into a first plurality of sub-communications. Each of the first plurality of optical fibers may receive one of the first plurality of sub-communications from the first optical line terminal and provides it to one of the plurality of customer premises.

### BACKGROUND OF THE INVENTION

This invention relates generally to Fiber-To-The-x (“FTTx”) telecommunication architectures. More specifically the invention relates to integration of management subsystems in FTTx telecommunication architectures.

FTTx telecommunication architectures are systems which are wholly, or at least partly, established using fiber optic technology. In prior art systems, optical splitters, the last piece of hardware before termination of optical lines at a customer premises optical network terminal were widely distributed, increasing maintenance and configuration costs.

The current invention provides solutions to these and other problems.

### BRIEF DESCRIPTION OF THE INVENTION

In one embodiment, a system for providing telecommunication services to a plurality of customer premises is provided. The system may include a central office and a first plurality of optical fibers. The central office may include a trunk line-out and a first optical line terminal. The first optical line terminal may be in communication with the trunk line-out via at least a first optical line. The first optical line terminal may also include a first optical splitter, internal to the first optical line terminal, configured to split a first communication travelling across the first optical line into a first plurality of sub-communications. Each optical fiber in the first plurality of optical fibers may receive one of the first plurality of sub-communications from the first optical line terminal and provides it to one of the plurality of customer premises.

In another embodiment, a system for providing telecommunication services to a plurality of customer premises is provided. The system may include a plurality of customer premises, a central office, and a first plurality of optical fibers. The central office may include a trunk line-out and a first optical line terminal. The first optical line terminal may be in communication with the trunk line-out via at least a first optical line. The first optical line terminal may also include a first optical splitter, internal to the first optical line terminal, configured to split a first communication travelling across the first optical line into a first plurality of sub-communications. Each optical fiber in the first plurality of optical fibers may receive one of the first plurality of sub-communications from the first optical line terminal and provides it to one of the plurality of customer premises. The system may also include a second optical line terminal. The second optical line terminal may be remote from the central office and in communication with the central office via at least a second optical line. The second optical line terminal may also include a second optical splitter, internal to the second optical line terminal, configured to split a second communication travelling across the second optical line into a second plurality of sub-communications. Each optical fiber in the second plurality of optical fibers may receive one of the second plurality of sub-communications from the second optical line terminal and provides it to one of the plurality of customer premises.

In another embodiment, a system for providing telecommunication services to a plurality of customer premises is provided. The system may include a first means, a second means, and a third means. The first means may be for communicating with a wide area network. The second means may be for providing a first optical communication line in communication with the first means. The third means may be for splitting the first optical communication from the second means into a plurality of optical communication lines. The second means may include the third means, and each of the plurality of optical communication lines may provide telecommunication services to one of the plurality of customer premises.

### BRIEF DESCRIPTION OF THE DRAWINGS

The present invention is described in conjunction with the appended figures:

FIG. 1 is a block diagram of an embodiment of the prior art for providing telecommunication services to customer premises;

FIG. 2 is a block diagram of an embodiment of the invention for providing telecommunication services to customer premises;

FIG. 3 is an axonometric view of an optical line terminal of the prior art; and

FIG. 4 is an axonometric view of an optical line terminal of the invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

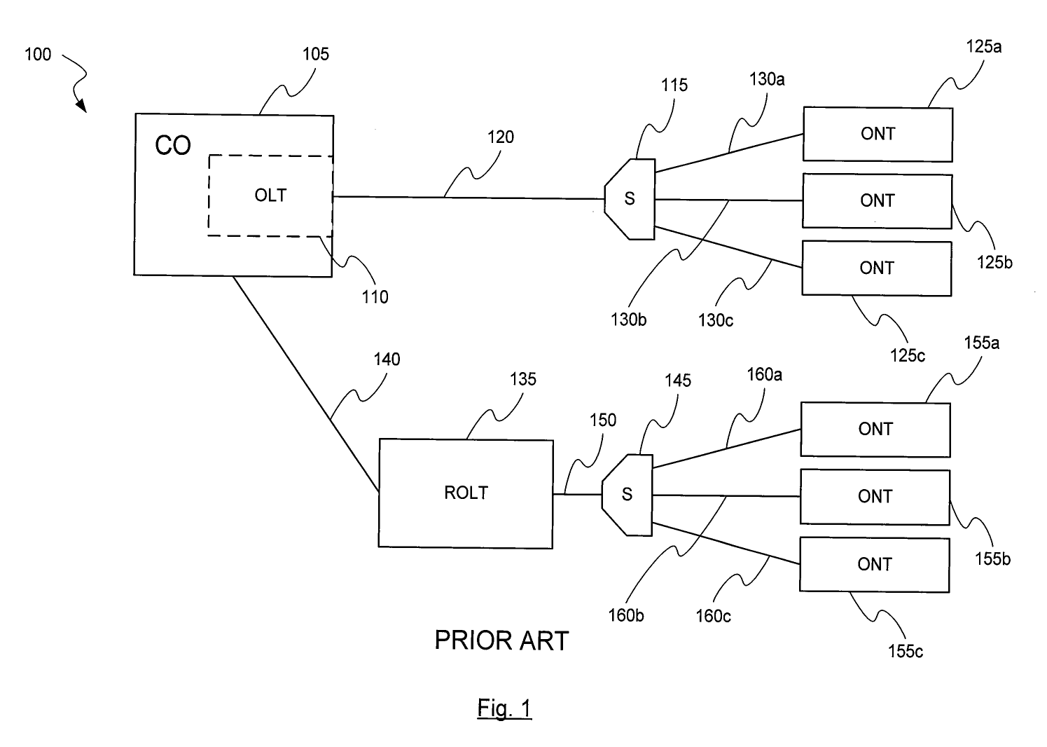

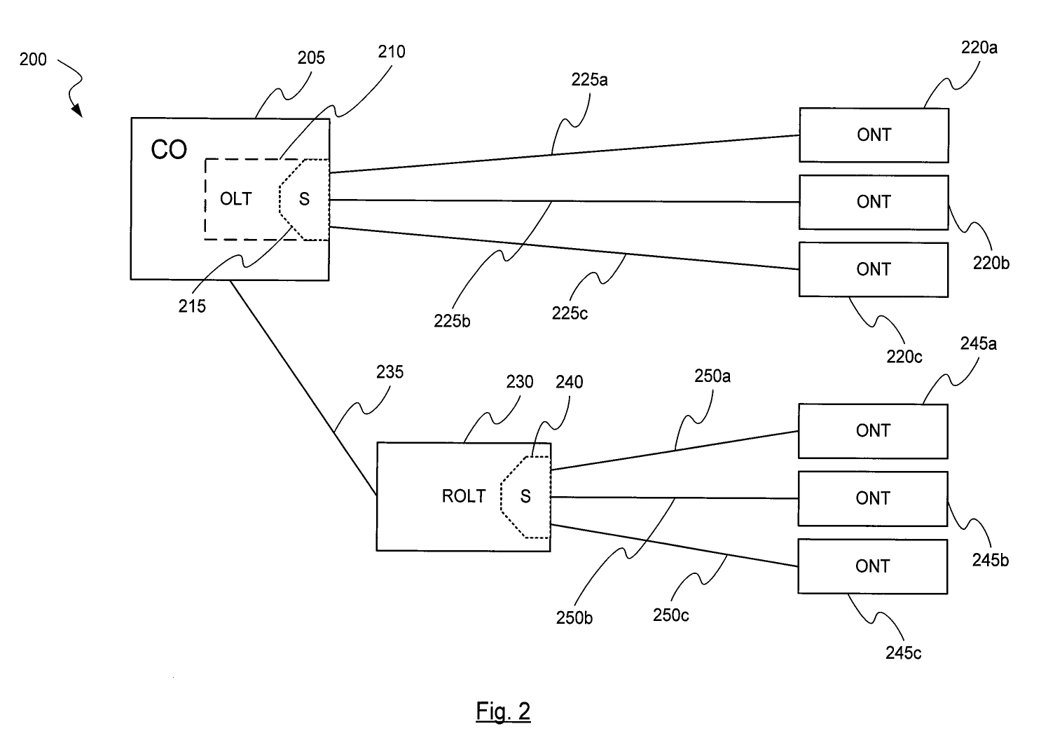

In one embodiment of the invention, a system for providing telecommunication services to a plurality of customer premises is provided. A prior art system is shown in FIG. 1, and an embodiment of the present invention is shown in FIG. 2.

In FIG. 1, system 100 may include a central office (“CO”) 105 having a local optical line terminal (“OLT”) 110. OLT 110 may be in communication with a trunk line-out at CO 105. OLT 110 may be in communication with a remote optical splitter 115 via optical line 120. Optical splitter 115 may be in communication with optical network terminals (“ONTs”) 125 via optical fibers 130.

An OLT 135, remote from CO 105, may be in communication with CO 105 via optical line 140. Optical splitter 145 may be in communication with OLT 135 via optical line 150. Optical splitter 145 may be in communication with ONTs 155 via optical fibers 160.

Splitters 115, 145 may be located remotely from CO 105, and may, for example, be located locally to ONTs 125, 155. Likewise, remote OLT 135 may also be located remotely from CO 105, but locally to ONTs 125, 155. ONTs 125, 155 may be located at customer premises and provide end-user telecommunication services thereto.

In FIG. 2, system 200 may include a CO 205 having a local OLT 210. OLT 210 may be in communication with a trunk line-out at CO 205. OLT 210 may include an integrated optical splitter 215. Integrated OLT 210/optical splitter 215 may be in communication with ONTs 220 via optical fibers 225.

An OLT 230, remote from CO 205, may be in communication with CO 205 via optical line 235. OLT 230 may include an integrated optical splitter. Integrated OLT 230/optical splitter 240 may be in communication with ONTs 245 via optical fibers 250. In some embodiments, services provided at ONTs 220 may be entirely configurable upstream from OLT 210.

Remote OLT 230 may be located remotely from CO 205, but locally to ONTs 220, 245. ONTs 220, 245 may be located at customer premises and provide end-user telecommunication services thereto. In some embodiments, services provided at ONTs 245 may be entirely configurable upstream from OLT 230. In other embodiments, services provided at ONTs 245 may be entirely configurable upstream from CO 205 or further upstream.

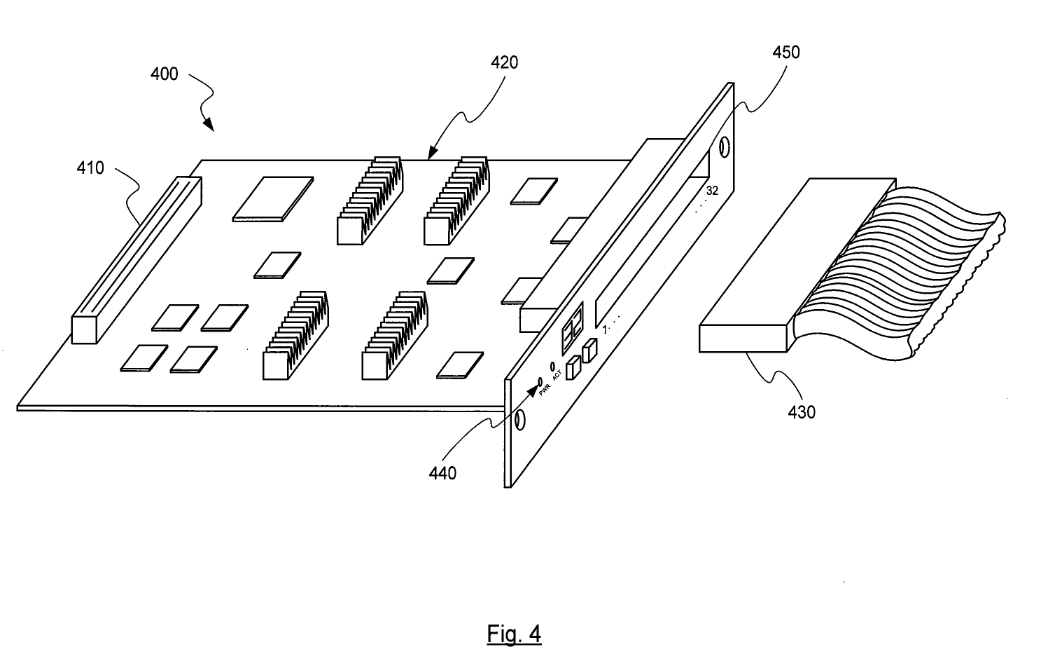

As can be seen by comparing FIG. 1 with FIG. 2, longer runs of optical fibers 225 and 250 are used in the present embodiment over the prior art, but synergies are created by combining optical splitters 215, 240 with OLTs 210, 230. Furthermore, new multi-fiber cabling and connecting of optical fibers to OLTs 210, 230, as will be further described below in reference to FIG. 4, allow for many more ONTs 220, 245 to be physically connected to, and serviced by, each integrated OLT/splitter combination. While only three ONTs 220, 245 are shown connected to each integrated OLT/splitter, one skilled in the art will recognize that any number of ONTs 220, 245 may be in communication with each integrated OLT/splitter.

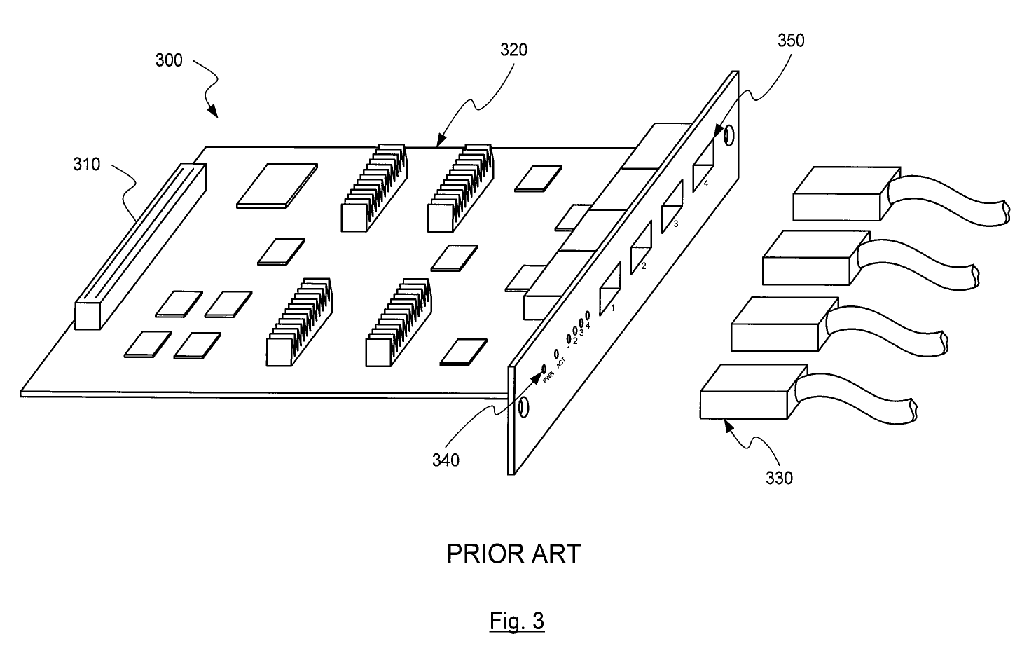

FIG. 3 shows an axonometric view of an OLT 300 of the prior art. FIG. 4 shows an axonometric view of an OLT 400 of the instant invention.

Prior art OLT 300 may have an interface 310 configured to communicate, either directly, or indirectly, with a wide area network. Circuitry 320 may allow communication to travel between the wide area network and optical fibers 330. OLT 300 may have indicators 340 which indicate the status of OLT 300. Such indicators 340 may include: a power indicator; an activity indicator; and status indicators for each optical fiber port 350. In this prior art embodiment, each of four optical fibers 330 is individually connected to OLT 300 via optical fiber ports 350.

OLT 400 of the instant invention may have an interface 410 configured to communicate, either directly, or indirectly, with a wide area network. Circuitry 420 may allow communication to travel between the wide area network and optical fibers 430.

OLT 300 may have indicators 440 which indicate the status of OLT 400. Such indicators 440 may include: a power indicator; an activity indicator; and a status indicator with buttons capable of determining the status for each optical fiber port 450. In this embodiment, all of the optical fibers 430 (thirty-two distinct optical fibers in this embodiment, less or more are possible in other embodiments) are collectively connected to OLT 400 via a multi-fiber cable and connector (in this example, a ribbon cable/connector) at optical fiber port 450.

In another embodiment of the invention, a system for providing telecommunication services to a plurality of customer premises is provided. The system may include a first means, a second means, and a third means.

In some embodiments, the first means may be for communicating with a wide area network. The first means may include, merely by way of example, a trunk line-out, a CO, an OLT, and/or any other equivalent for communicating with a wide area network now available or existing in the future.

In some embodiments, the second means may be for providing a first optical communication line in communication with the first means. The second means may include, merely by way of example, an OLT and/or any other equivalent for providing a first optical communication line in communication with the first means now available or existing in the future.

In some embodiments, the third means may be for splitting the first optical communication from the second means into a first plurality of optical communication lines. The third means may include, merely by way of example, an optical splitter and/or any other equivalent for splitting the first optical communication from the second means into a first plurality of optical communication lines now available or existing in the future.

In some embodiments, the second means may include the third means, and each of the plurality of optical communication lines may provide telecommunication services to one of the plurality of customer premises.

In some embodiments, the system may include a fourth means and a fifth means.

In some embodiments, the fourth means may be for providing a second optical communication line in communication with the first means. The fourth means may include, merely by way of example, an OLT and/or any other equivalent for providing a second optical communication line in communication with the first means now available or existing in the future.

In some embodiments, the fifth means may be for splitting the second optical communication from the fourth means into a second plurality of optical communication lines. The fifth means may include, merely by way of example, an optical splitter and/or any other equivalent for splitting the second optical communication from the fourth means into a second plurality of optical communication lines now available or existing in the future.

In some embodiments, the fourth means may include the fifth means, and each of the second plurality of optical communication lines may provide telecommunication services to one of the plurality of customer premises. In some embodiments, the fourth and fifth means may be remote from the first means, second means, and/or third means.

The invention has now been described in detail for the purposes of clarity and understanding. However, it will be appreciated that certain changes and modifications may be practiced within the scope of the appended claims.

What is claimed is:

1. A system for providing telecommunication services to a plurality of customer premises, wherein the system comprises:
a central office, wherein the central office comprises:
a trunk line-out; and
a first optical line terminal, wherein:
the first optical line terminal is in communication with the trunk line-out via at least a first optical line; and
the first optical line terminal comprises a first optical splitter, internal to the first optical line terminal, configured to split a first communication travelling across the first optical line into a first plurality of sub-communications; and
a first plurality of optical fibers, wherein each optical fiber in the first plurality of optical fibers receives one of the first plurality of sub-communications from the first optical line terminal and provides it to one of the plurality of customer premises.

2. The system for providing telecommunication services to a plurality of customer premises of claim 1, wherein the first plurality of optical fibers is coupled with the first optical line terminal via a multi-fiber cable and connector.

3. The system for providing telecommunication services to a plurality of customer premises of claim 1, wherein the telecommunication services provided to a particular customer premises are entirely configurable upstream from the first optical line terminal.

4. The system for providing telecommunication services to a plurality of customer premises of claim 1, wherein the system further comprises:
a plurality of customer premises;
a second optical line terminal, wherein:
the second optical line terminal is remote from the central office;
the second optical line terminal is in communication with the central office via at least a second optical line; and
the second optical line terminal comprises a second optical splitter, internal to the second optical line terminal, configured to split a second communication travelling across the second optical line into a second plurality of sub-communications; and
a second plurality of optical fibers, wherein each optical fiber in the second plurality of optical fibers receives one of the second plurality of sub-communications from the second optical line terminal and provides it to one of the plurality of customer premises.

5. The system for providing telecommunication services to a plurality of customer premises of claim 4, wherein the second plurality of optical fibers is coupled with the second optical line terminal via a multi-fiber cable and connector.

6. The system for providing telecommunication services to a plurality of customer premises of claim 4, wherein the telecommunication services provided to a particular customer premises are entirely configurable upstream from the second optical line terminal.

7. The system for providing telecommunication services to a plurality of customer premises of claim 1, wherein the system further comprises:
a second optical line terminal, wherein:
the second optical line terminal is remote from the central office;
the second optical line terminal is in communication with the central office via at least a second optical line; and
a second optical splitter, external to the second optical line terminal, configured to split a second communication from the second optical line into a first plurality of sub-communications; and
a second plurality of optical fibers, wherein each fiber in the second plurality of optical fibers receives one of the second plurality of sub-communications from the second optical splitter and provides it to one of the plurality of customer premises.

8. A system for providing telecommunication services to a plurality of customer premises, wherein the system comprises:
a plurality of customer premises;
a central office, wherein the central office comprises:
a trunk line-out; and
a first optical line terminal, wherein:
the first optical line terminal is in communication with the trunk line-out via at least a first optical line; and
the first optical line terminal comprises a first optical splitter, internal to the first optical line terminal, configured to split a first communication travelling across the first optical line into a first plurality of sub-communications;
a first plurality of optical fibers, wherein each optical fiber in the first plurality of optical fibers receives one of the first plurality of sub-communications from the first optical line terminal and provides it to one of the plurality of customer premises;
a second optical line terminal, wherein:
the second optical line terminal is remote from the central office;
the second optical line terminal is in communication with the central office via at least a second optical line; and
the second optical line terminal comprises a second optical splitter, internal to the second optical line terminal, configured to split a second communication travelling across the second optical line into a second plurality of sub-communications; and
a second plurality of optical fibers, wherein each optical fiber in the second plurality of optical fibers receives one of the second plurality of sub-communications from the second optical line terminal and provides it to one of the plurality of customer premises.

9. The system for providing telecommunication services to a plurality of customer premises of claim 8, wherein the first plurality of optical fibers is coupled with the first optical line terminal via a multi-fiber cable and connector.

10. The system for providing telecommunication services to a plurality of customer premises of claim 8, wherein the telecommunication services provided to a particular customer premises are entirely configurable upstream from the first optical line terminal.

11. The system for providing telecommunication services to a plurality of customer premises of claim 8, wherein the second plurality of optical fibers is coupled with the second optical line terminal via a multi-fiber cable and connector.

12. The system for providing telecommunication services to a plurality of customer premises of claim 8, wherein the telecommunication services provided to a particular customer premises are entirely configurable upstream from the second optical line terminal.

13. A system for providing telecommunication services to a plurality of customer premises, wherein the system comprises:
a first means for communicating with a wide area network;
a second means for providing a first optical communication line in communication with the first means;
a third means for splitting the first optical communication from the second means into a first plurality of optical communication lines; and
wherein:
the second means comprises the third means; and
each of the first plurality of optical communication lines provides telecommunication services to one of the plurality of customer premises.

14. The system for providing telecommunication services to a plurality of customer premises of claim 13, wherein the first means comprises a trunk line-out.

15. The system for providing telecommunication services to a plurality of customer premises of claim 13, wherein the second means comprises an optical line terminal.

16. The system for providing telecommunication services to a plurality of customer premises of claim 13, wherein the third means comprises an optical splitter.

17. The system for providing telecommunication services to a plurality of customer premises of claim 13, wherein the system further comprises:
a fourth means for providing a second optical communication line in communication with the first means;
a fifth means for splitting the second optical communication from the fourth means into a second plurality of optical communication lines; and
wherein:
the fourth means comprises the fifth means; and
each of the second plurality of optical communication lines provides telecommunication services to one of the plurality of customer premises

18. The system for providing telecommunication services to a plurality of customer premises of claim 17, wherein the fourth means comprises an optical line terminal.

19. The system for providing telecommunication services to a plurality of customer premises of claim 17, wherein the fifth means comprises an optical splitter

20. The system for providing telecommunication services to a plurality of customer premises of claim 17, wherein the fourth and fifth means are remote from the first means.
